(19) United States
(12) Patent Application Publication
(10) Pub. No.: US 2015/0116459 A1
(43) Pub. Date: Apr. 30, 2015

(54) SENSING DEVICE AND SIGNAL PROCESSING METHOD THEREOF

(71) Applicant: LIPS INCORPORATION, Taipei City (TW)

(72) Inventors: Ling-Wei LIU, Taipei City (TW); Hung-Chang TSAI, Taipei City (TW)

(73) Assignee: LIPS INCORPORATION, Taipei City (TW)

(21) Appl. No.: 14/243,914

(22) Filed: Apr. 3, 2014

(30) Foreign Application Priority Data
Oct. 25, 2013 (TW) 102138775

(51) Int. Cl. H04N 13/02; H04N 13/00

(52) U.S. Cl. CPC H04N 13/021; H04N 13/0271; H04N 13/0051
USPC 348/46

(57) ABSTRACT

A sensing device provided in the present invention includes a first sensor, a second sensor, a synchronizer, and a combiner. The first sensor has a first resolution and is configured to generate a first image data stream. The second sensor has a second resolution and is configured to generate a second image data stream. The second resolution is different from the first resolution. The synchronizer is electrically coupled to the first sensor and the second sensor and configured to control timing sequences of the first image data stream and the second image data stream such that the first image data stream and the second image data stream have synchronized vertical synchronization signals. The combiner is configured to combine the first image data stream and the second image data stream to form an output data stream.

### TECHNICAL FIELD OF THE INVENTION

This invention relates to a sensing device and a signal processing method thereof, and especially to a sensing device and a signal processing method being capable of combining multiple sensors with different resolutions.

### BACKGROUND OF THE INVENTION

In recent years, with the development of three-dimensional (3D) display technology, stereoscopic image processing has become increasingly important. In general, the stereoscopic images can be formed in the following ways: for example, using a depth camera which can obtain depth information to photograph, using dual cameras which can simulate human binocular vision to photograph, or performing an appropriate image processing for two-dimensional (2D) images to obtain the stereoscopic images.

The depth photography herein is to use a traditional RGB camera simultaneously with the depth camera to photograph. The depth camera is capable of calculating a distance between a subject and the camera through the principle of Time-of-Flight (ToF), which calculates time required for an infrared ray being issued from the depth camera and reaching the subject and than being reflected back to the depth camera.

Common products of the depth photography are like Microsoft's Kinect sensor, which is used for somatosensory games, or augmented reality (AR), which is used in an application of 3D virtual fitting rooms. However, both the RGB camera and the depth camera of the above-mentioned depth photography employ their respective image processors; thus, there is a bulky and costly problem. In addition, the data generated from the RGB and depth cameras are processed respectively. Therefore, there is a problem of a had experience in practical use at present. For example, the problem of poor sensitivity or slow response may occur in the games. In the example of the augmented reality, a situation of mismatch between a character and a background may occur, and there is still a shortcoming for the usage.

### SUMMARY OF THE INVENTION

Accordingly, an objective of the present invention is to provide a sensing device, which can synchronize and combine image data streams of two sensors respectively having two different resolutions, so that frames of the two sensors are synchronized so as to provide better subsequent applications.

Another objective of the present invention is to provide a signal processing method of a sensing device, which can control timing sequences of the image data streams of the two sensors having the two different resolutions, so that the two sensors have synchronized vertical synchronization signals, thereby solving the problem of the mismatch between the images and the depth.

To achieve the foregoing objectives, according to an aspect of the present invention, the sensing device provided in the present invention includes a first sensor, a second sensor, a synchronizer, and a combiner. The first sensor has a first resolution and is configured to generate a first image data stream. The second sensor has a second resolution and is configured to generate a second image data stream. Moreover, the second resolution is different from the first resolution. The synchronizer is electrically coupled to the first sensor and the second sensor and is configured to control timing sequences of the first image data stream and the second image data stream such that the first image data stream and the second image data stream have synchronized vertical synchronization (Vertical sync, Vsync) signals. The combiner is configured to combine the first image data stream and the second image data stream to form an output data stream.

In one preferred embodiment, the sensing device further includes a signal processor that is configured to process the output data stream to adapt to external applications.

In one preferred embodiment, the output data stream generates a plurality of data lines that form a frame. Moreover, the frame includes a first frame of the first image data stream and a second frame of the second image data stream, and sizes of the first frame and the second frame respectively correspond to the first resolution and the second resolution. Specifically, the size of the frame is about twice as the size of the larger of the first frame and the second frame.

In one preferred embodiment, the first sensor is a depth sensor; the second sensor is an image sensor. The first resolution of the depth sensor is less than the second resolution of the image sensor.

In one preferred embodiment, the combiner includes a line buffer or frame buffer.

In one preferred embodiment, the synchronizer provides a clock control signal for the first sensor and the second sensor. In addition, the synchronizer provides a delay control signal for one of the first sensor and the second sensor.

To achieve the foregoing objectives, the signal processing method of the sensing device provided in the present invention includes the steps of: generating a first image data stream by a first sensor having a first resolution; generating a second image data stream by a second sensor having a second resolution, wherein the second resolution is different from the first resolution; controlling timing sequences of the first image data stream and the second image data stream such that the first image data stream and the second image data stream have synchronized vertical synchronization signals; combine the first image data stream and the second image data stream to form an output data stream; and processing the output data stream for external applications.

In one preferred embodiment, the output data stream generates a plurality of data lines that form a frame. The frame includes a first frame of the first image data stream and a second frame of the second image data stream, and sizes of the first frame and the second frame respectively correspond to the first resolution and the second resolution. More specifically, the size of the frame is about twice as the size of the larger of the first frame and the second frame.

In one preferred embodiment, the first image data stream and the second image data stream have synchronized data line signals.

In one preferred embodiment, the step of controlling the timing sequences of the first image data stream and the second image data stream specifically includes the steps of: providing a clock control signal to the first sensor and the second sensor; and providing a delay control signal to one of the first sensor and the second sensor.

In comparison with the prior art, the present invention employs the synchronizer to synchronize clocks of the first sensor and the second sensor and to delay the data line signals sent from the sensor with the smaller resolution, so that the first sensor and the second sensor can achieve the transmission with the synchronized frames. That is to say, the first sensor and the second sensor have the synchronized vertical synchronization signals, whereby the shortcomings of the mismatch and the bad experience in the prior art can be overcome.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a functional block diagram illustrating a sensing device according to a preferred embodiment of the present invention;

FIG. 2 is a timing chart schematically illustrating a first image data stream and a second image data stream;

FIG. 3 is a timing chart schematically illustrating the first image data stream, the second image data stream, and an output data stream;

FIG. 4 is a schematic drawing illustrating a frame after combination; and

FIG. 5 is a flow chart illustrating a signal processing method of the sensing device according a preferred embodiment of the present invention.

### DETAILED DESCRIPTION OF THE INVENTION

The present invention will now be described in detail with reference to a few preferred embodiments thereof as illustrated in the accompanying drawings. The same reference numerals refer to the same parts or like parts throughout the various figures.

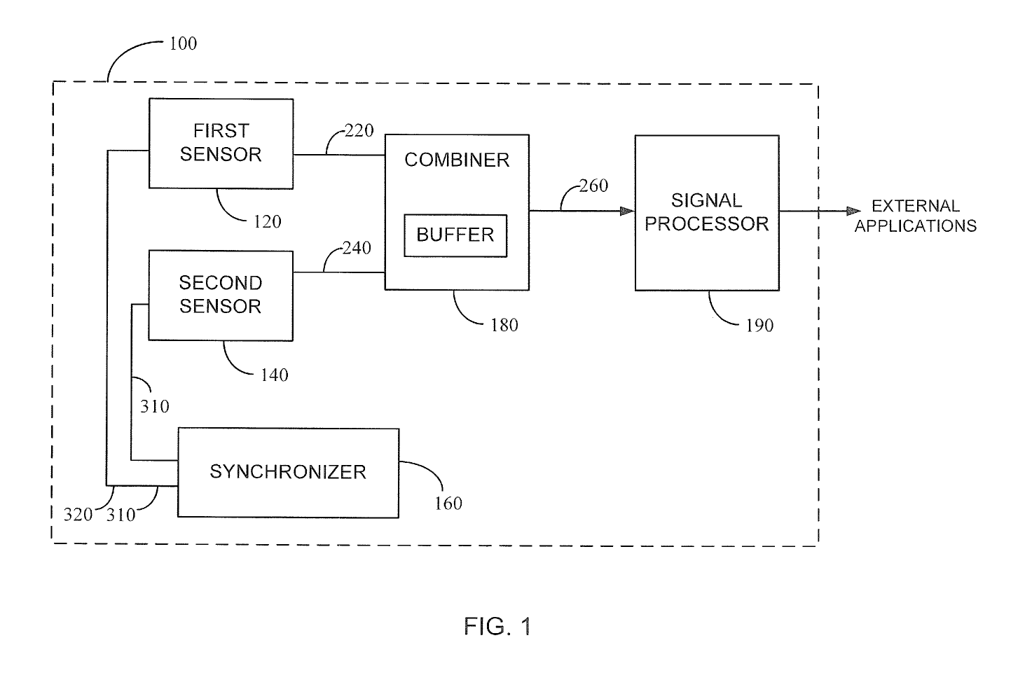

Referring to FIG. 1, FIG. 1 is a functional block diagram illustrating a sensing device according to a preferred embodiment of the present invention. In order to explain clearly, the sensing device 100 of the embodiment is shown as dashed lines. The sensing device 100 includes a first sensor 120, a second sensor 140, a synchronizer 160, a combiner 180, and a signal processor 190. It should be noted that the embodiment is illustrated by using the two sensors. However, the sensors of the present invention are not limited to the two sensors, and more than two sensors are also within the scope of the present invention. The above-mentioned synchronizer 160, combiner 180 and signal processor 190 can respectively be a chip, or they can be integrated into a System-on-a-Chip (SoC) for reducing volume and cost thereof.

Specifically, the first sensor 120 has a first resolution and is configured to generate a first image data stream 220. The first resolution of the first sensor 120 means an ability to sense a level of detail. Taking a RGB camera for example, it is an image resolution which can be captured by the RGB camera, e.g. VGA (640*480). Taking a depth camera for example, it is a resolution of a depth map which can be captured by the depth camera, e.g. QVGA (320*240). Similarly, the second sensor 140 has a second resolution and is configured to generate a second image data stream 240. The second resolution of the second sensor 140 means the ability thereof to sense the level of detail. Taking a RGB camera for example, it is an image resolution which can be captured by the RGB camera, e.g. VGA (640*480). Taking a depth camera for example, it is a resolution of a depth map which can be captured by the depth camera, e.g. QVGA (320*240). In the embodiment, the second resolution is different from the first resolution. It should be noted that the present invention is not limited to the combination of the depth camera and the RGB camera. Other arbitrary combinations from optical sensor, infrared sensor, ultrasonic sensor, CCD (Charge-Coupled Device) image sensor, CMOS(Complementary Metal Oxide Semiconductor) image sensor, and so on are within the scope of the present invention.

In the embodiment, the first sensor 120 is a depth sensor (e.g. the depth camera), and the second sensor is an image sensor (e.g. the RGB camera). The first resolution of the depth sensor is less than the second resolution of the image sensor. For example, the first resolution (i.e. the resolution of the depth map) is QVGA (320*240); the second resolution (i.e. the resolution of the captured image) is VGA (640*480). However, the present invention is not limited thereto. For example, a relation of the two resolutions that can be other multiples or the relation of the two resolutions that is not in proportional is also within the scope of the present invention.

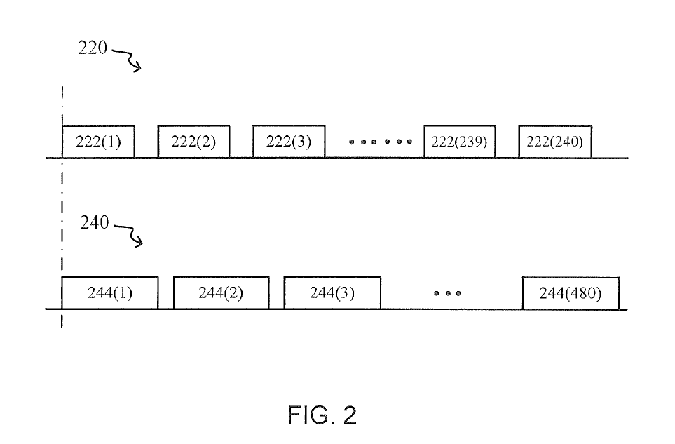

Referring to FIG. 1 and FIG. 2, FIG. 1 is a timing chart schematically illustrating the first image data stream 220 and the second image data stream 240. The synchronizer 160 is electrically coupled to the first sensor 120 and the second sensor 140, and it is configured to control timing sequences of the first image data stream 220 and the second image data stream 240 such that the first image data stream 220 and the second image data stream 240 have synchronized vertical synchronization signals. As shown in FIG. 2, the first image data stream 220 has a plurality of data line signals 222, and each of the data line signals 222 includes information of each of data lines. The data of a first frame which is captured by the first sensor 120 consists of the data lines. Therefore, the data line signals 222 includes the data line signal 222(1) of the 1st row, the data line signal 222(2) of the 2nd row, the data line signal 222(3) of the 3rd row, . . . and the data line signal 222(240) of the 240th row. Similarly, the second image data stream 240 has a plurality of data line signals 244, and each of the data line signals 244 includes information of each of the data lines. The data of a second frame which is captured by the second sensor 140 consists of the data lines. Therefore, the data line signals 244 includes the data line signal 244(1) of the 1st row, the data line signal 244(2) of the 2nd row, the data line signal 244(3) of the 3rd row, . . . and the data line signal 244(480) of the 480th row.

In the embodiment, the synchronizer 160 controls the timing which the first sensor 120 outputs the data line signal 222(1) of the 1st row being the same as the timing which the second sensor 140 outputs the data line signal 244(1) of the 1st row, as shown in FIG. 2. That is to say, the timing sequences of the first sensor 120 and the second sensor 140 outputting the first frame and the second frame are synchronizing, whereby they have the synchronized Vsync signals.

Referring to FIG. 1 again, the combiner 180 is configured to combine the first image data stream 220 and the second image data stream 240 to form an output data stream 260. Since the first sensor 120 and the second sensor 140 have the synchronized Vsync signals, during a frame time, the data received by the combiner 180 are the data which are captured by the first sensor 120 and the second sensor 140 at the same time. Therefore, the first sensor 120 and the second sensor 140 with two different resolutions can be synchronized, thereby overcoming the problem of the mismatch between the prior art depth and RGB cameras.

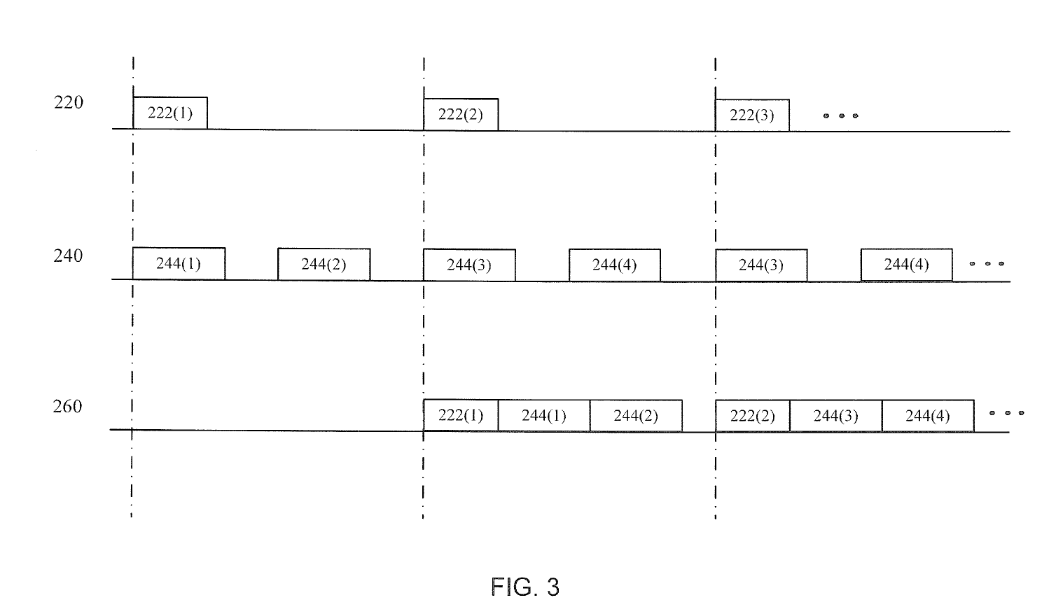

In the embodiment, the combiner 180 is utilized to generate the synchronized output data stream 260 according to the synchronizer 160. Specifically, the combiner includes a buffer 182. In addition, the synchronizer 160 provides a clock control signal 310 for the first sensor 120 and the second sensor 140. Meanwhile, the synchronizer 160 provides a delay control signal 320 for one of the first sensor 120 and the second sensor 140. More specifically, referring to FIG. 3, FIG. 3 is a timing chart schematically illustrating the first image data stream 220, the second image data stream 240, and the output data stream 260. In this example, the synchronizer 160 provides the delay control signal 320 for the first sensor 120 such that each of the data line signals 222 outputted from the first sensor 120 delays one period of the data line. That is to say, after waiting for the second sensor 140 to output the two data line signals 244, the first sensor 120 begins to output the next data line signal 222.

On the other hand, the buffer 182 of the combiner 180 is preferably a line buffer. After the line buffer receives the data line signal 222(1) of the 1st row of the first image data stream 220 and receives the data line signal 244(1) of the 1st row and the data line signal 244(2) of the 2nd row of the second image data stream 240, it combines the three and then outputs. Subsequently, after the line buffer receives the data line signal 222(2) of the 2nd row of the first image data stream 220 and receives the data line signal 244(3) of the 3rd row and the data line signal 244(4) of the 4th row of the second image data stream 240, it combines the three and then outputs, and the rest may be deduced by analogy, thereby forming the output data stream 260. Therefore, a capacity of the line buffer can hold one row of the data line signal 222 and two rows of the data line signal 244.

Therefore, in the example that the first sensor 120 is the depth sensor (320*240) and the second sensor 140 is the image sensor (640*480), when the first sensor 120 outputs the data lines (i.e. the 240th row) of the entire frame completely, the second sensor 140 also outputs the data lines (i.e. the 480th row) of the entire frame completely, so that the first image data stream 220 and the second image data stream 240 are synchronized. Subsequently, the output data stream 260 is provided to the signal processor 190, and the signal processor 190 formats the output data stream 260 into a format which is suitable for an external host, such as signals which are provided to a display for display of the images or provided to the external host for executing other applications. Therefore, the two sensors can only employ a single signal processor, whereby the cost of the signal processors respectively used by each of the sensor can be saved.

It is worth mentioning that the clock of the combiner 180 can be twice or more as much as the clock of the first sensor 120 or the second sensor 140, so as to perform the synchronization of the data processing.

However, in other embodiments, the synchronizer 160 controls the timing sequences of the first image data stream 220 and the second image data stream 240, so that the first image data stream 220 and the second image data stream 240 have the synchronized data line signals. That is to say, the data line signals of the first image data stream 220 and data line signals of the second image data stream 240 may be synchronous.

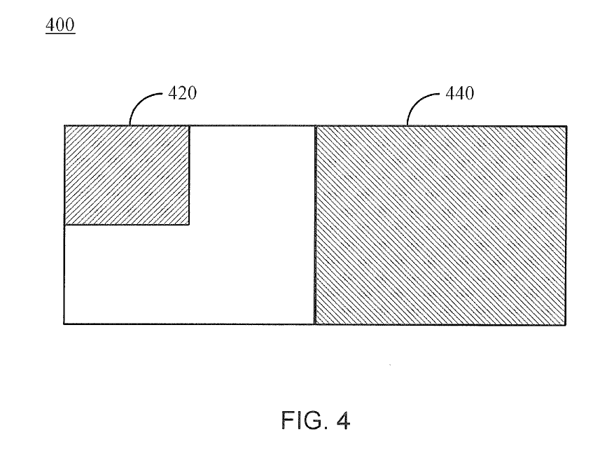

Referring to FIG. 4, FIG. 4 is a schematic drawing illustrating a frame after the combination. In the embodiment, the output data stream 260 generates a plurality of data lines that form a frame 400. The frame 400 includes a first frame 420 of the first image data stream 220 and a second frame 440 of the second image data stream 240, and sizes of the first frame 420 and the second frame 440 respectively correspond to the first resolution and the second resolution. That is to say, the size of first frame 420 is 320*240, and the size of the second frame 440 is 640*480. More specifically, the size of the frame 400 is about twice as the size of the larger of the first frame 420 and the second frame 440. In this example, the size of the frame 400 is 1280*480. It is worth mentioning that contents of the frame 400 can be the information consisting of a mix of the first frame 420 and the second frame 440 in other embodiments, but not the two frames being directly joined together. Then the actual images can be obtained by an external decoder.

In another embodiment, the buffer 182 of the combiner 180 is a frame buffer. That is to say, the capacity of the frame buffer can hold a first frame 420 and a second frame 440. The synchronizer 160 provides the delay control signal 320 for the first sensor 120 such that the first sensor 120 stops outputting for a period of the first frame 420 after the first sensor 120 outputs the first frame 420 completely, and then begins to output the next first frame 420. That is to say, the first sensor 120 can wait until the second sensor 140 completely outputs the second frame 440 and then resumes outputting the next first frame 420, thereby achieving the synchronized vertical synchronization signals. After the frame buffer receives the first image data stream 220 of one first frame 420 and the second image data stream 240 of one second frame 440, the frame buffer generates the output data stream 260 of the combination for achieving the requirement of the synchronization.

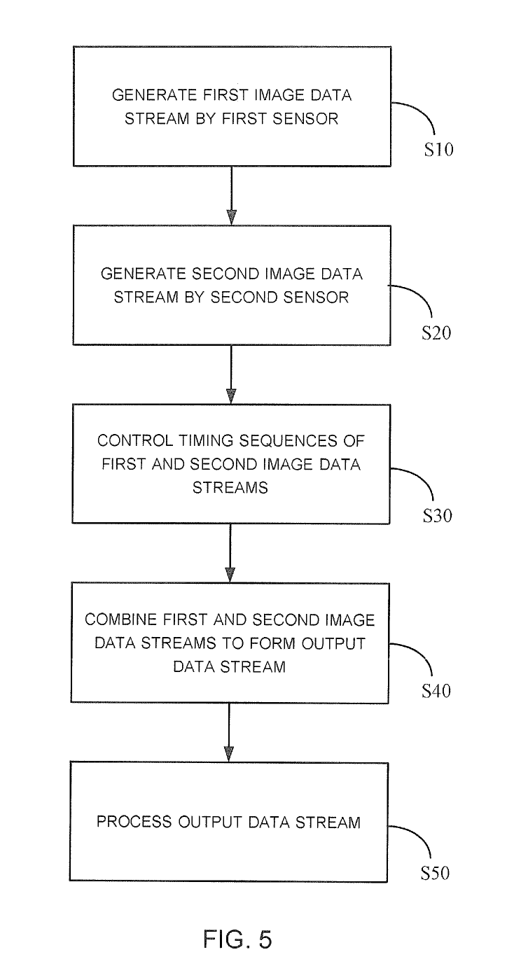

What follows is a detail of a signal processing method adopting the sensing device 100 of the embodiment. Referring to FIG. 1 and FIG. 5, FIG. 5 is a flow chart illustrating a signal processing method of the sensing device according a preferred embodiment of the present invention. The signal processing method of the embodiment is used for the above-mentioned sensing device 100, and the descriptions of the following elements have been explained as above mention, so we need not go into detail herein.

The signal processing method begins with step S10. At step S10, the first sensor 120 which has the first resolution generates the first image data stream 220.

At step S20, the second sensor 140 which has the second resolution generates the second image data stream 240. Moreover, the second resolution is different from the first resolution.

At step S30, the timing sequences of the first image data stream 220 and the second image data stream are controlled such that the first image data stream 220 and the second image data stream 240 have the synchronized vertical synchronization signals, and then execution resumes at step S40. It is worth mentioning that the steps S10 to S30 are executed at the same time preferably.

At step S40, the first image data stream 220 and the second image data stream 240 are combined to form an output data stream 260, and then execution resumes at step S50.

At step S50, the output data stream 260 is processed for external applications.

Similarly, referring to FIG. 4, the output data stream 260 generates the plurality of data lines that form the frame 400. The frame 400 includes the first frame 420 of the first image data stream 220 and the second frame 440 of the second image data stream 240, and the sizes of the first frame 420 and the second frame 440 respectively correspond to the first resolution and the second resolution. More specifically, the size of the frame 400 is about twice as the size of the larger of the first frame 420 and the second frame 440.

More specifically, at step S30, the step of controlling the timing sequences of the first image data stream 220 and the second image data stream 240 specifically includes the steps of: providing the clock control signal 310 to the first sensor 120 and the second sensor 140; and providing the delay control signal 320 to one of the first sensor 120 and the second sensor 140. However, in other embodiments, two different delay control signals may be simultaneously provided to the first sensor 120 and the second sensor 140, thereby achieving the more complex synchronization for the multiple sensors.

In summary, the preferred embodiment of the present invention employs the synchronizer 160 to synchronize the clocks of the first sensor 120 and the second sensor 120 and to delay the data line signals sent from the sensor with the smaller resolution, so that the first sensor 120 and the second sensor 140 can achieve the transmission with the synchronized frames. That is to say, the first sensor 120 and the second sensor 140 have the synchronized vertical synchronization signals, whereby the shortcomings of the mismatch and the bad experience in the prior art can be overcome.

While the preferred embodiments of the present invention have been illustrated and described in detail, various modifications and alterations can be made by persons skilled in this art. The embodiment of the present invention is therefore described in an illustrative but not restrictive sense.

What is claimed is:

1. A sensing device, comprising:
a first sensor having a first resolution and configured to generate a first image data stream;
a second sensor having a second resolution and configured to generate a second image data stream, wherein the second resolution is different from the first resolution;
a synchronizer electrically coupled to the first sensor and the second sensor and configured to control timing sequences of the first image data stream and the second image data stream such that the first image data stream and the second image data stream have synchronized vertical synchronization signals;
a combiner configured to combine the first image data stream and the second image data stream to form an output data stream.

2. The sensing device of claim 1, further comprising a signal processor configured to process the output data stream to adapt to external applications.

3. The sensing device of claim 1, wherein the output data stream generates a plurality of data lines that form a frame.

4. The sensing device of claim 3, wherein the frame comprises a first frame of the first image data stream and a second frame of the second image data stream, and sizes of the first frame and the second frame respectively correspond to the first resolution and the second resolution.

5. The sensing device of claim 4, wherein the size of the frame is about twice as the size of the larger of the first frame and the second frame.

6. The sensing device of claim 1, wherein the first image data stream and the second image data stream have synchronized data line signals.

7. The sensing device of claim 1, wherein the first sensor is a depth sensor, and the second sensor is an image sensor.

8. The sensing device of claim 7, wherein the first resolution of the depth sensor is less than the second resolution of the image sensor.

9. The sensing device of claim 1, wherein the combiner comprises a line buffer.

10. The sensing device of claim 1, wherein the combiner comprises a frame buffer.

11. The sensing device of claim 1, wherein the synchronizer provides a clock control signal for the first sensor and the second sensor.

12. The sensing device of claim 11, wherein the synchronizer provides a delay control signal for one of the first sensor and the second sensor.

13. A signal processing method of a sensing device, comprising:
generating a first image data stream by a first sensor having a first resolution;
generating a second image data stream by a second sensor having a second resolution, wherein the second resolution is different from the first resolution;
controlling timing sequences of the first image data stream and the second image data stream such that the first image data stream and the second image data stream have synchronized vertical synchronization signals;
combine the first image data stream and the second image data stream to form an output data stream; and
processing the output data stream for external applications.

14. The method of claim 13, wherein the output data stream generates a plurality of data lines that form a frame.

15. The method of claim 14, wherein the frame comprises a first frame of the first image data stream and a second frame of the second image data stream, and sizes of the first frame and the second frame respectively correspond to the first resolution and the second resolution.

16. The method of claim 15, wherein the size of the frame is about twice as the size of the larger of the first frame and the second frame.

17. The method of claim 13, wherein the step of controlling the timing sequences of the first image data stream and the second image data stream specifically comprises the steps of:
providing a clock control signal to the first sensor and the second sensor; and
providing a delay control signal to one of the first sensor and the second sensor.
